(19) United States
(12) Patent Application Publication
(10) Pub. No.: US 2003/0096537 A1
(43) Pub. Date: May 22, 2003

(54) Digital filter adaptor

(76) Inventor: Yakov Belopolsky, Harrisburg, PA (US)

Correspondence Address: Woodcock Washburn LLP, One Liberty Place - 46th Floor, Philadelphia, PA, 19103, US

(21) Appl. No.: 10/040,590

(22) Filed: Nov. 19, 2001

(51) Int. Cl. H01R 24/00

(52) U.S. Cl. 439/676

(57) ABSTRACT

A digital filter adapter in accordance with the invention comprises a first connector for connecting to an interface of an electronic device, an electrical signal filter, and a connector receptacle for connecting to a communication channel or cable. Electronic signals received from an electronic device into the adapter are routed through the electrical signal filter, which is typically implemented on a printed circuit board, and communicated through the connector receptacle to a communication cable. The connector receptacle provides the same interface as the electronic device to which the first connector is designed to be attached. Thus, the adapter can be inserted between the electronic device and a communication cable which, in the absence of the adapter, could be connected directly to the electronic device.

### FIELD OF THE INVENTION

The present invention relates to electrical connectors and more particularly, to electrical connectors in which electronic noise filtering systems are incorporated.

### BACKGROUND OF THE INVENTION

There is a need in the field of electronics, and digital computers in particular, to perform electronic filtering on digital signals communicated between digital devices for the purpose of reducing or eliminating noise. Early filtering techniques were relatively simple and inexpensive to implement. For example, capacitive low-pass filters comprised wrapping a wire around a digital communication channel. Such low pass filters attenuate high frequency signals above a prescribed threshold frequency while allowing low frequency signals to pass through. Such low-pass filtering techniques have proven to be sufficient for many basic analog applications. However, digital signals often comprise high and low frequency harmonics and application of low pass filters result in distortion of the digital signal. Accordingly, digital applications require more advanced filtering techniques.

Typically, more advanced digital signal filtering systems are implemented on printed circuit boards. For example, an advanced digital filtering system may comprise a pulse transformer, common mode chokes, and resistive networks. Additional precision inductors and capacitors may be included for applications such as RF circuits that require precise tuning.

Of course, there is a cost associated with implementing noise filtering functionality on a circuit board. This is especially true when a circuit board design for a device is complete and adding filtering functionality requires redesign of the circuit board. It would be a great improvement in the field to have systems and methods that provide for advanced digital filtering without requiring the redesign of existing circuit boards.

Applicants have also noted that many existing electronic devices and systems, which were designed and built prior to the establishment of stringent filtering standards, are adequate in all respects except for filtering. Furthermore, many existing systems serve multiple purposes, some of which do not require filtering. Therefore, it would be a great improvement in the art to have systems and methods that provide for electronic filtering in existing electronic equipment on an as-needed basis.

### SUMMARY OF THE INVENTION

Applicant addresses these and other limitations in the art with a digital filter adapter that is connected between an electronic device and the communication bus which, in the absence of the adapter, would be directly connected to the electronic device. The adapter operates to filter the electronic signals traveling to and from the electronic device and thereby meet advanced filtering standards. The adapter can be attached to existing equipment so as to meet filtering regulations but can also be easily removed.

A digital filter adapter in accordance with the invention comprises a first connector for connecting to an interface of an electronic device, an electrical signal filter, and a connector receptacle for connecting to a communication channel or cable. Electronic signals received from an electronic device into the adapter are routed through the electrical signal filter, which is typically implemented on a printed circuit board, and communicated through the connector receptacle to a communication cable. According to an aspect of the invention, the connector receptacle provides the same interface as the electronic device to which the first connector is designed to be attached. Thus, the adapter can be inserted between the electronic device and a communication cable which, in the absence of the adapter, could be connected directly to the electronic device.

According to an aspect of the invention, the first connector of the adapter may be a plug for interfacing with a modular phone jack. Further, the connector receptacle may be configured with an interface of a modular phone jack for designed to accept the plug end of telephone transmission cable. Thus, the digital filter adapter may be connected to a modular jack in an electronic device and the plug end of a telephone cable placed in the connector receptacle of the adapter. Digital communications to and from the digital device are filtered by the electrical signal filter in the adapter.

### BRIEF DESCRIPTION OF THE DRAWINGS

The digital filter adapter of the present invention is further described with reference to the accompanying drawings in which:

FIG. 1A is a side view a digital filter adapter in accordance with an aspect of the invention;

FIG. 1B is a top view of the digital filter adapter shown in FIG. 1;

FIG. 2 is a front view of a receptacle end of a digital filter adapter in accordance with an aspect of the invention;

FIG. 3 is a side view of the digital filter adapter shown in FIG. 1 with an outer housing shown in section;

FIG. 4A is a side view of the digital filter adapter shown in FIG. 1 with an outer housing removed;

FIG. 4B is a top view of the digital filter adapter shown in FIG. 1 with an outer housing removed;

FIG. 4C is a top view of the digital filter adapter shown in FIG. 1 with an outer housing and phone jack component removed; and

FIG. 5 is a circuit diagram of a digital filter suitable for use with the present invention.

### DETAILED DESCRIPTION OF THE PREFERRED EMBODIMENTS

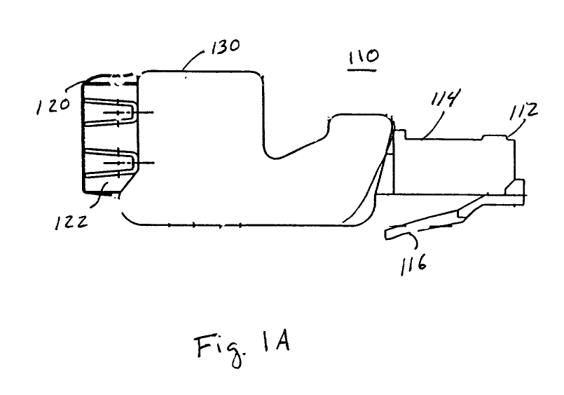

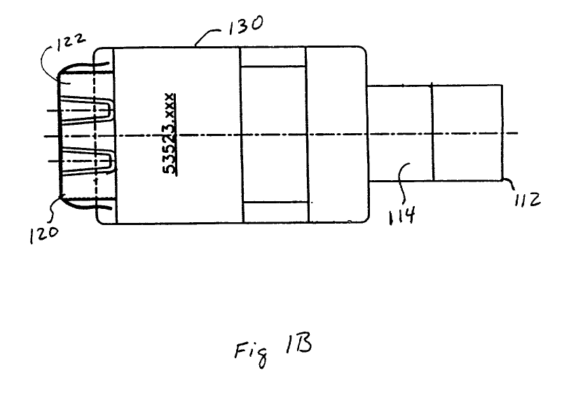

A digital filter adapter with the above-mentioned beneficial features in accordance with a presently preferred exemplary embodiment of the invention will be described below with reference to FIGS. 1A through 5. The description given herein with respect to those Figures is for illustrative purposes only and is not intended in any way to limit the scope of the invention. Questions regarding the scope of the invention may be resolved by referring to the appended claims.

Referring to FIGS. 1A and 1B, side and top views of a digital filter adapter 110 in accordance with the invention are shown. Digital filter adapter 110 comprises a first connector 112 for interfacing with an electronic device such as, for example, a personal computer. In the illustrative embodiment, first connector 112 has the format of a modular plug designed for interfacing with a modular phone jack receptacle. Connector 112 may be, for example, a modular plug such as is disclosed in U.S. Pat. No. 4,698,025, the contents of which are hereby incorporated by reference in their entirety. In the illustrative embodiment, connector 112 comprises a plug housing 114 having a plurality of terminals (not shown) therein. The terminals are adapted to electrically contact conductors disposed in a socket of an electronic device and extend into a cable at the opposing end of housing 114. A manually actuated flexible lower latch 116 is formed on the plug housing 114 to lock and remove the connector 112 from a socket in an electronic device. Those skilled in the art will recognize that while connector 112 is described as a plug connector in the illustrative embodiment, connector 112 may have other forms such as, for example, a modular jack connector, USB connector, SCSI connector, 1394 Infiniband connector, RS-232 connector, Metagig connector, VHSDC Metral connector, etc.

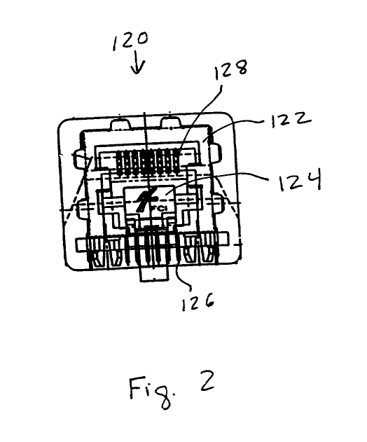

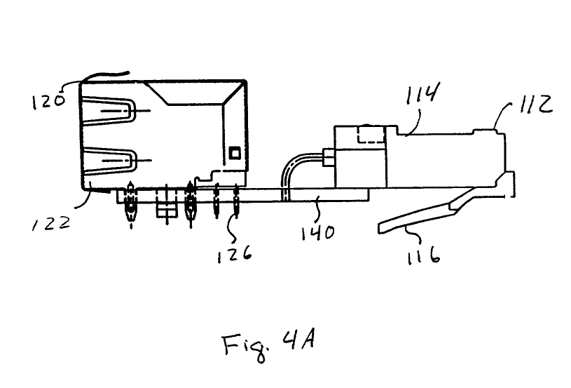

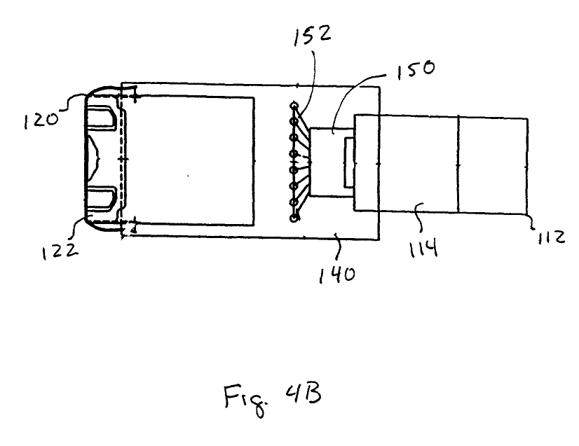

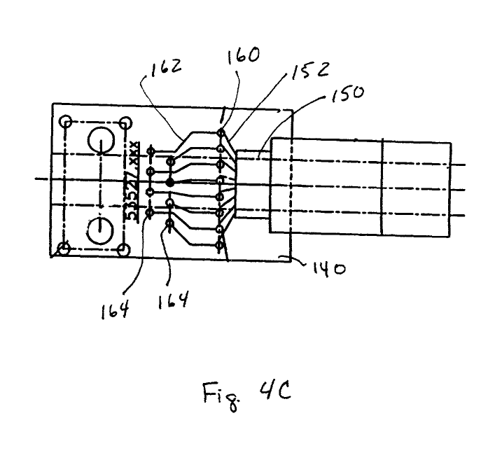

Digital filter adapter 110 further comprises connector receptacle 120 for receiving a communication cable. In the illustrative embodiment, connector receptacle 120 has the format of a modular phone jack such as is disclosed in U.S. Pat. No. 4,698,025, the contents of which are hereby incorporated by reference in their entirety. As shown in FIG. 2, receptacle 120 comprises a housing 122 enclosing and defining a plug receiving socket 124 and a conductor having lead portion 126 and contact portion 128. When the plug end of a communication cable is inserted into socket 124, the electrical leads of the cable are placed in contact with contact portion 128. Furthermore, as is discussed below in connection with FIG. 4A and 4B, lead portions 126 are in electrical communication with an electrical filtering circuit. According to an aspect of the invention, receptacle 120 has the same interface format as that which connector 112 is designed to interface, i.e. the electronic device with which the adapter is used. Thus, the adapter 110 can be inserted between the electronic device and a communication cable which, in the absence of the adapter, could have been connected directly to the electronic device. Those skilled in the art will recognize that while receptacle 120 is described in the illustrative embodiment as having characteristics of phone jack, receptacle 120 may take other forms such as, for example, a modular jack receptacle, USB receptacle, SCSI receptacle, 1394 Infiniband receptacle, RS-232 receptacle, Metagig receptacle, VHSDC Metral receptacle, etc.

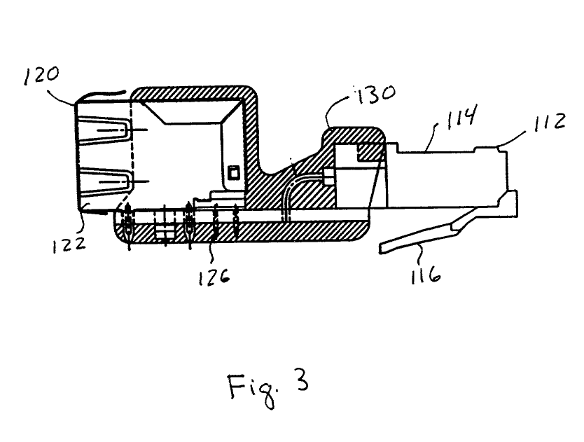

Digital filter adapter 110 also comprises cover section 130. In the illustrative embodiment, cover section 130 envelopes a portion of connector 112 and receptacle 120. Cover section 130, which appears in section in FIG. 3, also envelopes printed circuit board 140 to which connector 112 and receptacle 120 are attached. Cover section 120 thereby operates to protect the connections between connector 112 and receptacle 120 to printed circuit board 140 from dirt and physical manipulation.

FIGS. 4A and 4B, provide a side and top view of adapter 110 with cover 130 removed. As shown, connector 112 has cable 150 extending therefrom. Cable 150 comprises a plurality of communication lines 152 therein which terminate on printed circuit board 140 and communicate with a filter circuit comprised on circuit board 140. Conductor leads 126 extend from connector 120 into printed circuit board 140 wherein they electrically communicate with the filter circuit. Thus, an electrical path is created from connector 112 through cable 150, through an electrical circuit on printed circuit board 140, and into receptacle 120 through leads 126. FIG. 4C provides a top view of adapter 110 with cover 130 and receptacle 120 removed. As shown, lines 152 terminate at points 160 on PCB 140. Printed circuit board traces 162 communicate signals through the electrical filter circuit, to points 164 wherein leads 126 from receptacle 120 are connected.

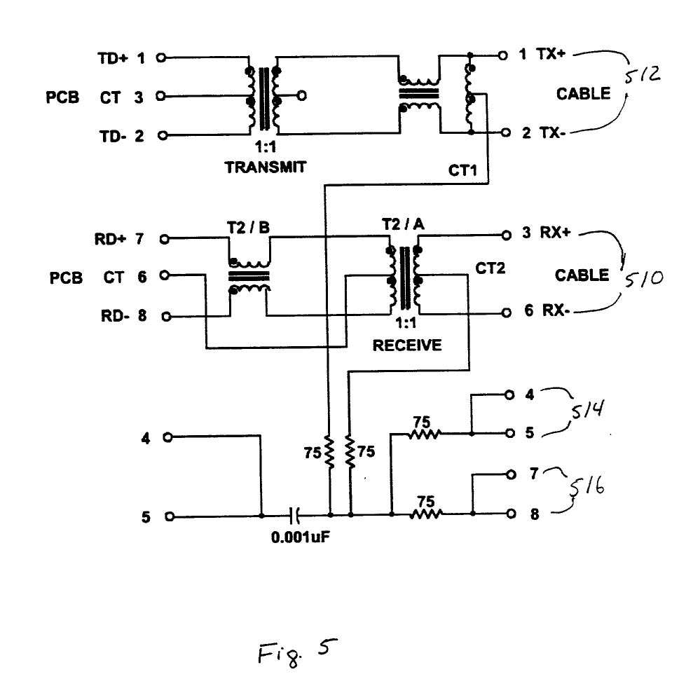

FIG. 5 is a circuit diagram of an illustrative digital filter for use in an adapter in accordance with the invention. The circuit diagram depicts eight terminals for connection to a PCB and eight terminals which are electrically connected to a transmission cable. A first pair of terminals 510 on the cable side are for receiving signals and a second set of terminals 512 on the cable side are for receiving signals. For each terminal pair, a transformer is used to separate dangerous voltages and provides fault protection, and a common mode choke is used to reduce noise on the lines. Remaining terminal pairs 514 and 516 provide a common ground.

Thus, there has been disclosed a filter adapter that may be connected between an electronic device and a communication cable for the purpose of filtering electronic signals passed between the electronic device and a communication cable. The adapter can be attached to existing equipment so as to meet recently instituted electronic filtering requirements. The inventive adapter is ideal for use with end of life products where it is not economically feasible to redesign the product to meet new filtering requirements. Because the adapter is removable, it can be used on an as-needed basis. The adapter is particularly well suited for testing electronic filters for use with particular electronic equipment. Because the adapter is removable, various filters can be tested and analyzed without having to implement the filters on circuit boards internal to the electronic devices. In addition to providing filtering capabilities, the adapter also operates to reduce emissions and can be used in the field as an add-on to meet FCC emissions regulations.

The present invention may be employed in other specific forms without departing from the spirit or essential attributes thereof. For example, an adapter in accordance with the present invention may be manufactured to accommodate any number of different filtering circuits. Also, various different types of interfaces may be employed in the connector and receptacle to accommodate electrical devices with corresponding interfaces. Accordingly, the present invention should not be limited to any single embodiment, but rather construed in breadth and scope in accordance with the recitation of the appended claims.

1. A digital filter adapter, comprising:
a connector, said connector for connecting to the output of an electronic device;
a filter circuit electrically connected to said connector, said filter circuit reducing noise in electrical signals transmitted through said adapter; and
a receptacle, said receptacle electrically connecting to said filter circuit and having the same output as said electronic device.

2. The digital filter adapter of claim 1, wherein said connector comprises a plug for interfacing with a modular jack.

3. The digital filter adapter of claim 2, wherein said receptacle comprises a modular jack.

4. The digital filter adapter of claim 1, wherein said interface of said receptacle is adapted to receive the terminal end of a communication cable.

5. The digital filter adapter of claim 4, wherein said interface of said receptacle is adapted to receive the plug end of a communication cable.

6. The digital filter adapter of claim 1, further comprising a printed circuit board, wherein said filter circuit is located on said printed circuit board and said connector and receptacle are mechanically connected to said printed circuit board.

7. A digital filter adapter for filtering electrical signals communicated to and from an electronic device, comprising:
a printed circuit board having a filter circuit comprised thereon, said filter circuit reducing noise in electrical signals transmitted through said adapter;
a connector for connecting to an output interface of an electronic device, said connector electrically connected to said filter circuit; and
a receptacle electrically connected to said filter circuit, said receptacle having an interface analogous to the output interface of the electronic device.

8. The digital filter adapter of claim 7, wherein said connector comprises a plug for interfacing with a modular jack.

9. The digital filter adapter of claim 7, wherein said receptacle comprises a modular jack.

10. The digital filter adapter of claim 7, wherein said interface of said receptacle is adapted to receive the terminal end of a communication cable.

11. The digital filter adapter of claim 10, wherein said interface of said receptacle is adapted to receive the plug end of a communication cable.

12. A method of filtering noise in electrical signals transmitted to and from an electronic device comprising the steps of:
providing a digital filter adapter, wherein the digital filter adapter has a connector for connecting to an output interface of an electronic device, a filter circuit electrically connected to the connector and reducing noise in electrical signals transmitted through said adapter, and a receptacle electrically connected to the filter circuit, the receptacle having an interface analogous to the output interface of the electronic device;
connecting the connector of the digital filter to an electronic device; and
connecting the receptacle to a communication cable.

13. The method of claim 12, wherein said step of providing a digital filter adapter comprises providing an adapter having a plug adapted for insertion into a jack in an electronic device, a filter circuit electrically connected to said plug, and a jack adapted to receive a plug connector and electrically connected to the filter circuit.

14. The method of claim 13, wherein said step of connecting the connector of the digital filter adapter to an electronic device comprises inserting the plug into a jack in the electronic device, and said step of connecting the receptacle to a communication cable comprises inserting the plug connector of a communication cable into the jack in the digital filter adapter.

15. A digital filter adapter, comprising:
a plug for insertion into a plug receptacle of a digital device, said plug comprising a plurality of electrical leads for making electrical contact with electrical leads in the plug receptacle;
an electrical circuit electrically connected to at least one of said plurality of electrical leads in said plug, said electrical circuit for reducing electromagnetic interference caused by said electricity traveling in said at least one of said plurality of electrical leads in said plug; and
a plug receptacle for receiving a plug, said plug receptacle comprising a plurality of electrical leads, wherein at least one of said plurality of electrical leads is electrically connected to said electrical circuit.
